(19) United States
(12) Patent Application Publication
(10) Pub. No.: US 2007/0209601 A1
(43) Pub. Date: Sep. 13, 2007

(54) Method of training dogs

(76) Inventors: Vladislav Roytapel, Troy, MI (US); Bonita Wainz-Atkinson, Royal Oak, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/370,412

(22) Filed: Mar. 8, 2006

(51) Int. Cl. A01K 37/00

(52) U.S. Cl. 119/712

(57) ABSTRACT

In a method of training a dog, a line is provided to connect a trainer with the dog to ensure a leading position of the trainer, a command is generated by the trainer in an assertive fashion and with a stern facial expression, and a frozen posture is created by the trainer to thereby produce in the dog an instinctive perception of a threat of an inevitable bite in case of disobedience. An acoustic bag can be used that emits a clearly distinguishable sound when thrown and thus surprises the dog and interrupts its unwanted behavior bringing it to a halt. Reinforcing commands is also provided by mimicking motions and postures used in a canine world to show dominance. A reward to consolidate progress in training and make it habitual is provided, the reward being presented by generating a high-pitch intonation message of gratitude and by a treat.

### COPYRIGHT NOTICE

© Copyright 2006, Vladislav Roytapel and Bonita Wainz-Atkinson. All Rights Reserved.

A portion of the disclosure of this patent document contains material which is subject to copyright protection. The copyright owners have no objection to the facsimile reproduction by anyone of the patent document or the patent disclosure, as it appears in the U.S. Patent and Trademark Office patent file or records, but otherwise reserve all copyrights whatsoever.

### BACKGROUND OF THE INVENTION

1. Field of the Invention

The present invention relates generally to the area of behavior modification of animals. More specifically, this invention pertains to a method and technique for training dogs.

2. Description of the Related Art

Known in the art are a number of methods of training dogs. Some of them are disclosed in such patent publications as US20040079296A1 for “Animal Training Apparatus and Method” that provides causing a negatively reinforcing event to occur upon a dog to irritate the dog and thus refrain it from jumping on a standing trainer, U.S. Pat. No. 6,311,645 for “Animal Training Method and Apparatus,” which describes interrupting the animal's vision to deliver a training stimulus by providing a controllable lens with an electro-optic shutter placed within the animal's field of vision, U.S. Pat. No. 6,311,644 for “Apparatus and Method for Animal Behavior Tracking, Predicting and Signaling” teaching the use of a computer for housebreaking puppies, U.S. Pat. No. 5,351,653 for “Animal Training Method Using Positive and Negative Audio Stimuli,” the method including a consistent positive audio tone capable of being sensed by the animal without startling the animal, and a consistent negative audio tone distinct from the positive audio tone capable of being sensed by the animal and startling the animal, etc.

In the training of dogs, most trainers use a leash and a collar and correct backwards saying heal. This is done repeatedly until eventually the dog understands the command. This is also called compulsion. Alternatively, trainers create pressure causing discomfort until the dog does what is asked. Nose collars or special training harness are used for that purpose, or the leash is wrapped around the dog's body, once again causing discomfort when the dog pulls. Still another way is to try and manipulate the dog using food.

### SUMMARY OF THE INVENTION

The main object of the method according to the present invention is to obtain maximum results in training in limited time and with minimum force. The present invention making use of mimicking canine language is based on the presumption that dog's behavior at every point is very predictable. If it is predictable it is preventable because it is correctable. As it is the case for the methods known in the art, the present invention also proceeds from the fact that a dog is a creature of habits. However, forming those habits is performed through the succession of surprise, which creates attention, which creates respect and admiration that result in obedience. The surprise is achieved by a combination of vocal commands, which in conjunction with dog's language form what is called Doglish in the art, and mimicking dog's motions.

According to the invention, training a dog to follow a command is performed by the steps of providing a line between a trainer and the dog to ensure a leading position of the trainer, generating a message of a command with ascending or descending intonation, and creating a frozen posture by the trainer, to thereby produce in the dog an instinctive perception of a threat of an inevitable bite in case of disobedience.

To ensure following the command by the dog, the message is generated in an assertive growling fashion.

To further ensure following the command, an acoustic bag is provided that emits a clearly distinguishable sound when flying in the air and thus surprises the dog and interrupts its unwanted behavior bringing it to a halt.

Ensuring the leading position of the trainer, when on the walk, is achieved by a swift motion of the trainer's body, which motion is direction-reverse with regard to a dog's motion, and a scissor-like motion of trainer's hands to thereby create a snap on the line, preferably prior to a dog's pulling action, and to take the dog aback, whereby dog's attention is intercepted, additional surprise is formed in it, and the transformation of the dog from a leader to a follower is thus secured.

Alternatively, ensuring the leading position of the trainer, especially when training small or sensitive dogs, is achieved by a swift motion of the trainer's body, which motion is direction-reverse with regard to a dog's motion, and a snapping action of a trainer's free hand wrist to thereby take the dog aback, whereby dog's attention is intercepted, additional surprise is formed in it, and the transformation of the dog from a leader to a follower is thus secured.

To train a sit command, a step of trainer's leaning over the dog, the trainer baring teeth, is added, to thereby provide perception in the dog that the trainer is taller than the dog, whereby a message of dominance is conveyed to the dog.

To reinforce the sit command, simulating of biting in pressure points in the rump of the dog is administered in conjunction with leaning over the dog's shoulder simulating the threat of biting the dog around the neck as dogs do among themselves in a similar situation.

To consolidate progress in training and make it habitual, a reward is provided by generating a high-pitch message of gratitude created with descending intonation, which message can be accompanied by a treat.

The method of the invention can also be amplified by adding a dominance/relaxation exercise to cure aggressiveness and hyperactivity of the dog. For larger dogs, but not limited to these, the steps of the dominance/relaxation exercise are implemented by having the dog either standing or sitting, preferably sitting, and the owner standing. The dog's head faces owner's right hand with the dogs rump area braced against owner's left foot having dog's spine perpendicular to owner's feet, the technique being transposed or mirrored if the dog's head and body face the opposite direction. The owner will hold (or grab) the collar in his right hand and place his left hand on the side of the dog's body that is opposite to the side that is near the owner's leg. The left hand will grab (or “bite”) in the area of the chest that is just above the dog's front leg. From this position, the owner will simultaneously twist his right hand towards himself in a counter clockwise motion, as if he was turning a wrench, the movement raising the dog up slightly and pushing the dog's head and shoulders onto the leg. Simultaneously the left hand pushes the dog into owner's leg, this action placing the dog's body onto owner's leg. The owner will slightly move back to allow the dog's body to gently slide down the owner's leg placing the dog sideways in the down position. Once the dog is down on its side, the owner will gently glide with the left hand along the dog's head until its fingers enclose the muzzle, the right hand still holding the dog down by the collar. The left thumb is placed on top of the dog's jaw with other fingers planted under the jaw gently keeping the dog's mouth closed, the hand being used as a jaw and the fingers as teeth, an exact simulation to what a mother dog would do. The owner holds the dog in this position until it accepts human authority. In this way, the dog loses its social status and accepts owner's higher social status. Once the dog relaxes as it would with its own mom, the hands are switched. The right hand goes to the muzzle to continue holding it gently closed as the left hand goes to the dog's chest, whereby the dog is completely relaxed and accepts owner's authority to being touched and handled. The whole exercise imitates how a mother dog would hold down their puppies. Enclosing the muzzle with the hand is also how a dog would grab another dog's muzzle to enforce its dominance.

For non-aggressive small dogs or puppies, but not limited to these, the dominance/relaxation exercise starts by kneeling upright, making sure that the dog's rump is resting up against the left knee. The right hand is placed under the collar palm up and points towards the dog's head with the thumb facing the owner. The left hand is placed above the dog's elbow where the leg meets the chest. Then the right hand will twist towards owner's body in a counter clock-wise fashion. The left hand slightly lifts the dog's body as it is being pulled onto owner's leg. Then the owner slightly moves the legs backwards to let the dog's body slide off the legs and onto the floor on its side. With the right hand still holding down the collar, the left hand is placed palm down onto the side of the dog's chest. The right hand will then glide along the dog's head until the fingers enclose the jaw. The right thumb plants itself under the jaw and the fingers keep the mouth closed. Once the dog has settled, the right hand around the muzzle is released, the left hand being kept planted on the dog's chest. In this position, the dog is calmly praised and stroked, all parts of the dog's body, especially the feet, ears and teeth, being touched. Thus the dog learns to accept owner's authority and love touch, which is no different from what a mother dog does when she turns over her puppies to groom them or holds them down to discipline them.

Other objects, features and advantages of the invention will be better understood from the following detailed description and drawings that follow.

### BRIEF DESCRIPTION OF THE DRAWINGS

FIG. 1 illustrates the way a trainer's hand hits the line showing a scissor action to draw dog's attention;

FIG. 2 shows the posture of the trainer giving a SIT command and prepared to reinforce the same;

FIG. 3 illustrates the posture of the trainer reinforcing the SIT command;

FIGS. 4a and 4b depict, respectively, an initial posture of the trainer prior to using a body posture to obligate the dog to obey a DOWN command, and the posture of the trainer implementing the DOWN command;

FIG. 5 illustrates the posture of the trainer reinforcing the DOWN command;

FIGS. 6A and 6B show a succession of steps for an alternative way of correcting the dog to draw their attention;

FIGS. 7a-7d illustrate the postures of the trainer in a four-step process of drawing dog's attention (stepping back, pivoting, acting scissor-like by hands, and having the dog back to the trainer's left side again walking on a loose line;

FIGS. 8a and 8b show how the dog is surprised after the pivot and scissor action getting them back to the trainer's left side and paying attention again;

FIG. 9 depicts an initial posture of the trainer when doing the dominance/relaxation exercise;

FIG. 10 illustrates a second step of the dominance/relaxation exercise to have the dog leaning on the trainer's leg;

FIG. 11 shows how, in implementing the dominance/relaxation exercise, the trainer holds the dog in the position to secure its relaxation;

FIG. 12 depicts the posture of the trainer during the last step of the dominance/relaxation exercise;

FIG. 13 illustrates an alternative initial posture of the trainer when doing the dominance/relaxation exercise;

FIG. 14 shows the second step of the alternative dominance/relaxation exercise where the dog is lifted on the trainer's leg;

FIG. 15 depicts the last step of the alternative dominance/relaxation exercise where the dog is held in the position to relax;

FIG. 16 shows the posture of the trainer when utilizing the mystical acoustic bag; and

FIG. 17 illustrates the dog having switched its attention to the mystical acoustic bag.

### DESCRIPTION OF THE PREFERRED EMBODIMENTS

It is presumed that whenever, throughout the specification, claims and abstract, ‘he,’ ‘him’ or ‘his’ may appear with regard to a dog's trainer, people of either sex are meant. Also, for the purpose of the present application, trainer, owner, or handler are interchangeable terms.

Dog training consists of the teaching of a dog to perform certain tasks at any given time. According to the present method, dog training techniques can be applied towards behavioral problems, examples of which being aggression, barking, chewing, jumping, digging, etc., and problems in obedience training, the examples of the latter being pulling the owner on the leash by the dog, dog's not coming when called, dog's not sitting or staying sit, dog's not going in the down position or not staying down, and so on.

Conventionally, the teaching is reduced to establishing the language, in which to communicate, and it does not seem to address the true problems, which are relationship problems. In too many households, there is a leader type of the dog and a follower type of the owner. As will be shown below, the present invention method based on making use of canine language puts the owner in a leading position and the dog in a following one. For example, urging a dog to sit in conventional methods of dog training is about manipulating the dog into a sit position or putting the dog in a sit by using trainer's hands. Similarly, training the dog to do the down is—in the art—a concept of getting a dog to lie down usually through manipulating with food or pulling out the legs until the dog actually lies down in the prostrate position. For some people, their dog will only do down when it is given a treat, otherwise they never get the dog down.

Addressing the root cause of the behavior problem, the present invention is applicable to every typical household. According to the method of the invention, the training is initiated by special body block techniques, particularly using a hand and fingers as jaws and teeth and specific canine-mimicking-type sound pronounced with a raising intonation. With the present method, dogs take the required position as they would submit to what can be called Alpha rules where Alpha implies the owner. Three Alpha rules are: (1) Alpha says once only; (2) Alpha never says anything that cannot be enforced; and (3) Alpha always enforces what he says. Alpha expresses itself (himself) through leadership and access to privileges. Leadership shows up through directing dog's activity. Alpha starts everything, Alpha finishes everything, and Alpha always wins. Privileges are expressed through priority access to the valuable resources. For example, Alpha eats first, sleeps higher, goes first through an entrance, etc.

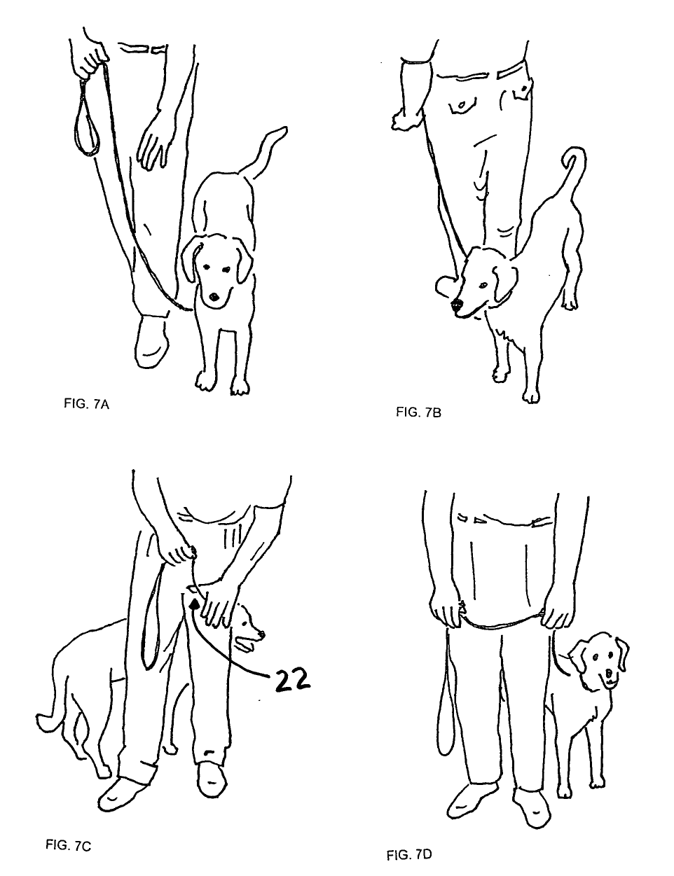

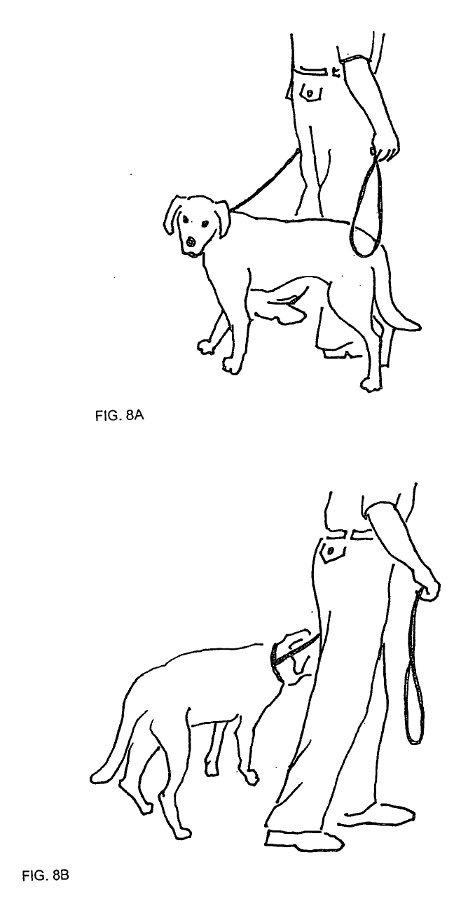

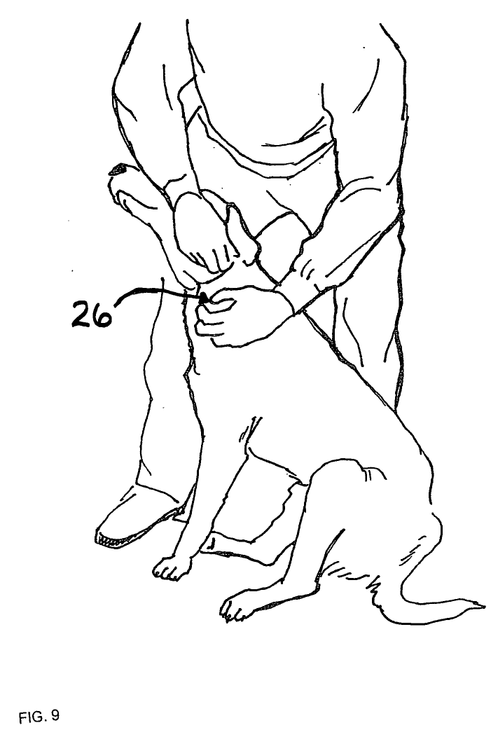

The present methods stipulates that urging a dog to pay attention comprises, the second the dog gets ahead of the owner, owner's stepping back (FIG. 7A), turning around up to 180° (FIG. 7B) and then making a scissor action with his hands (FIG. 7C). This is to be preferably done before the dog can achieve a pulling action. By doing that, the owner makes the dog focus on the owner. Thus the dog cannot be ahead, and it cannot lead anymore if it cannot be ahead, and it will follow (FIG. 7D) as it cannot lead. In dog training, a typical approach to verbally correct the dog, is just to say YES or NO (approval or disapproval) and then correct. Unlike a conventional method of training where trainers try to customize their dogs to the owners' needs, the present invention focuses on dogs' needs. A human, being a more intelligent species, can conform to the dogs' way of thinking, thus ensuring that a dog live in our world in harmony. Specifically, the present invention provides an approach of imitating a sound that is closer to dog's growl, in conjunction with moving the body of the trainer in the way to convey a message to the dog that if it does not stop, he will bite. Similarly, in conventional training of a dog to prevent it from behaving inappropriately, e.g. jumping, barking, etc., most trainers either use a shaking can or correct physically. In the present method, another special sound is used generated from what can be called (and explained below in more detail) a Mystical Acoustic Bag, in conjunction with a trainer's body motion, which communicates to the dog that if it keeps unyielding with this behavior, then he will bite.

The Mystical Acoustic Bag 20 used in the invention is a light sound-generating and behavior-interrupting device. The Mystical Acoustic Bag, when being tossed and landing, creates, by its flight and sound, a surprising effect that startles the dog out of any bad things that it is doing (see FIG. 17). Though the Mystical Acoustic Bag can be realized in various ways, the simplest of them is putting a chain, preferably a metallic one, in a small cloth bag. The real effect of using the Mystical Acoustic Bag, however, arises when the sound the bag produces is accompanied by pronouncing a canine raising sound AAAT (or AAAHT) by a handler and his body language showing an attempt to move forward and then taking a freezing pose. Any sound from the combination of the letter of A or AH is effective, because it imitates growl. Having “T” at the end is important because the trainer is clapping his teeth thereby.

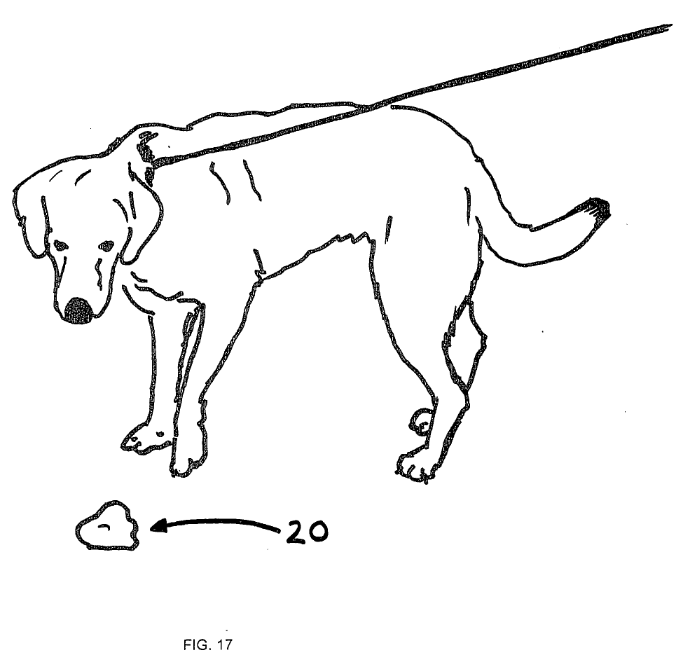

And the most effective way comes when all the three components are presented simultaneously acting as handler's virtual teeth: tossing the Mystical Acoustic Bag towards the dog, uttering AAAT imitating growling as a warning, and freezing. The bag needs to be tossed in a certain way. To help keep the bag mystical, the dog must not know the handler has the bag. There are several steps to using the bag: the handler hides the bag in either right or left hand, making sure not to let it make any sound; he will toss the bag in a sideways direction; as he tosses, he will step forward and emit the sound AAAT; and he freezes on the spot and stares sternly in the dogs' eyes (FIG. 16). As will be shown below in more detail, virtual teeth, according to the present invention, may also be presented by the collar and line, pressure points, and finger correction with the left hand. It is a fact that the dogs' mom, in the case of disobedience of her puppies, will move suddenly towards an assertive puppy while growling, with stern eyes, and then freeze. So what is being done according to the invention is a kind of replica of canine language that humans can use. It produces the effect of a direct and imperative talk to dogs. As a result, the dog refocuses its attention back on the handler, and thus again can be taught.

The foundation of the present method lies in teaching a dog to pay attention, and instead of conventional methods using treats to bribe the dog, it is proposed to catch its attention and keep it by using an element of surprise. There are the following main positions that a dog can assume in its attempt to manipulate and not to follow a new leader, the dog's owner. The dog will try to go ahead and lead. Alternatively, it may try to lag or fall behind, as a way to still control the owner. Or the dog will go to the right side or to the left by tying up the owner. The fifth position is all over at once including jumping.

In the process of implementing the method, the dog is on the line, the difference between line and leash being in that the line is an ultra light, “weightless” string that gives the dog the sense of not being on the leash, but providing the handler with the tools and ability to reinforce rules instantly and under any circumstance and not chasing the dog. According to the proposed dog training method, the line should be attached to the collar at all times when the dog is with the human inside or outside. Preferably, the line should be of two types differing in sizes: up to about eight feet long for the inside use (though, room permitting, it can be longer) and up to about 20 feet for the outside use. From the dog's prospective, the handler becomes a miracle man, because he seems to be able to reinforce the rules remotely. Dogs do not understand the mechanism of reinforcement but what they do understand is that miraculously they become reachable by the handler so the game with him is going to be over.

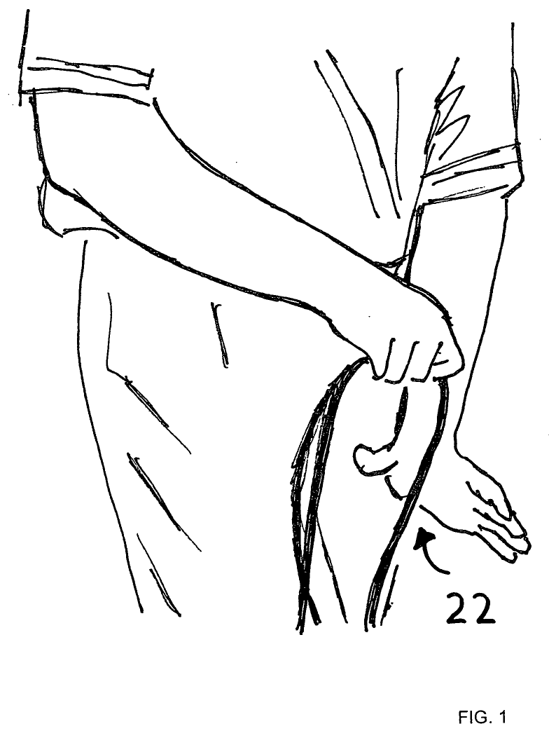

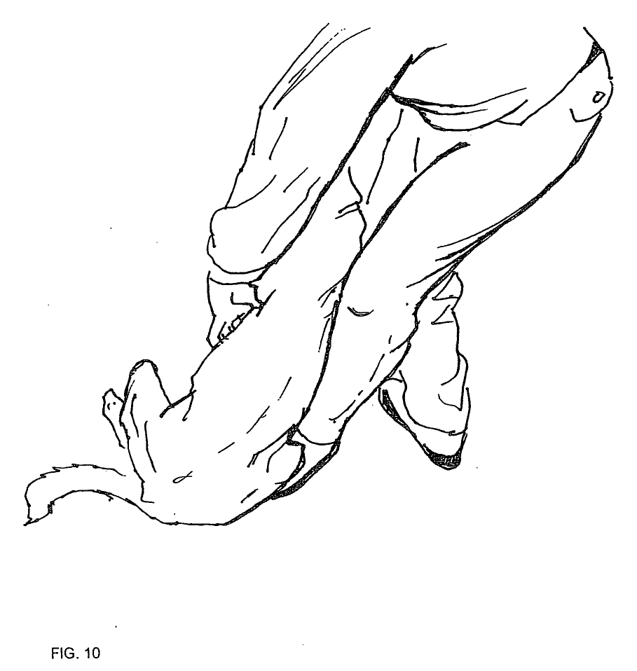

According to the present invention, teaching the dog to follow rather than to lead is performed as follows (FIGS. 7A-7D). As the dog starts going ahead, and before the line gets tight, the trainer steps back with the right foot (FIG. 7A) and, at the same time, throws the line towards the dog's rear. Then the trainer swings his body by about 180 degrees (FIGS. 7B, 8A). After that, his right and left hands move in a scissor-like motion creating a quick snap on the line, which catches the dog's attention, similar to a dog bite, and he forms a “C” 22 with his left hand fingers (FIGS. 1, 7C), as the line will hit between the thumb and the index finger. The left hand is aimed towards the line just below the right hand. The left hand hits the line as the right hand moves towards trainer's left biceps. The left and right hands move very quickly so as to release any tension on the line. When done correctly, the dog only gets a quick pop rather than a pull, and tremendous surprise is produced on its end of the line. This procedure changes the dog's mood from a leader to a follower (FIGS. 7D, 8B) and allows the owner to get his dog to walk on a loose line within just a few minutes.

The above steps are described assuming that the dog walks being on the left side of the owner's body, which is a sort of a standard in the U.S. If the dog is positioned on the owner's left side and goes ahead, his right foot needs to step back in order to pivot or abruptly change directions. (Were it the left foot to step back with subsequent pivoting or changing directions as described in the above, two things would happen: the owner and the dog would get tangled in the line, and the dog would also end up on the right side of the owner's body.) When the owner steps back with the right foot and pivots to the right, the dog and owner fluidly stay in sync. The dog stays on the left and doesn't get tangled in the line. It is understood, however, that it is not a limiting condition, and the method of the present invention is fully applicable to the situation when the dog walks on the right side of the owner's body, the required operations mirroring sidewise the above-described order.

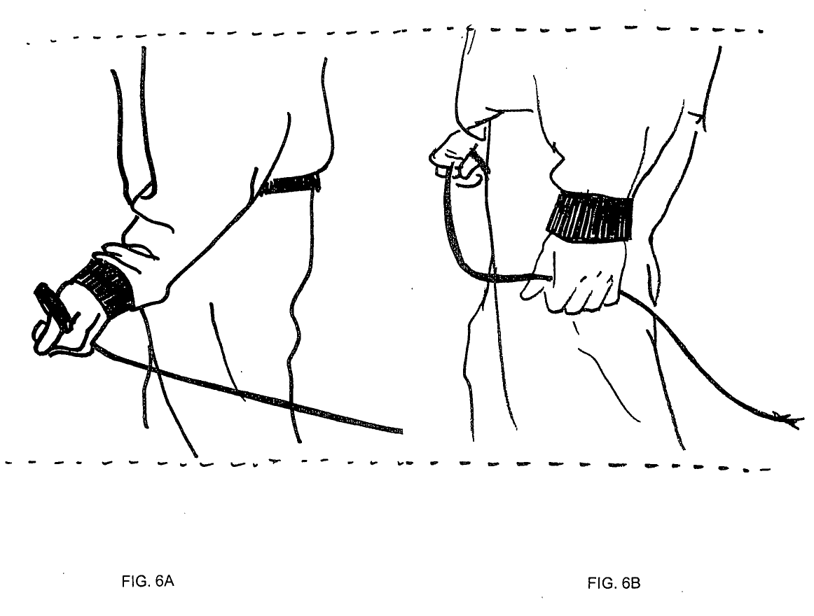

Preferably for little dogs or more sensitive dogs, but not limited to these, a modified version is suggested. The owner also steps back when the dogs gets ahead. However; the line is not thrown. The owner still needs to pivot around in the opposite direction except he will need to keep his left hand behind them a little (see FIGS. 6A, B). Once the pivot is complete, a quick pop (going forward—FIG. 6A—and then quickly back—FIG. 6B) is then given in the forward direction.

When the owner approaches a door, with the dog on his left side, the dog has two choices: (1) to go ahead showing no respect, and if it makes this choice, the owner will do the pay attention exercise (pivot and correct, as explained in the above), or (2) show respect by staying back and letting the owner pass. The dog will also sit allowing him to pass first. If the dog makes the correct choice and sits, the owner passes through the door and tells the dog to follow, accompanied by praise, “GOOD DOG”.

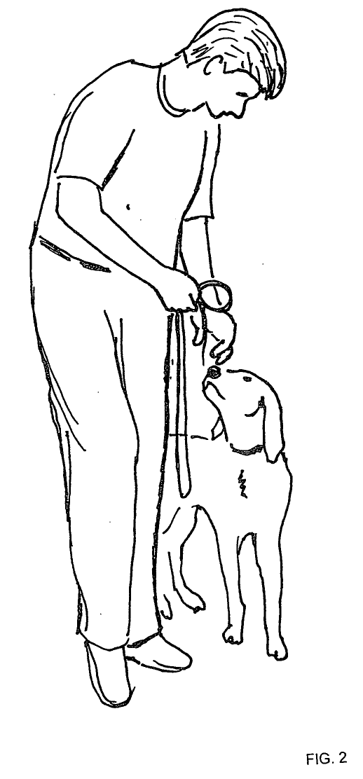

For the owner to establish himself as a leader from the psychological point of view, he needs to exonerate himself around the house. This can be done by following what may be called the Obedience for Life system. This system starts by ensuring that a dog is in either of the following three positions. First position is on a line (of, for example, 3/32- 3/16 inch thick) attached to the dog's collar and cut to the length that is conducive to an owner's living area. Whenever the dog is out of the kennel, this line has to be attached to the dog's collar by one end. The other end is left unattached to anything and dragging on the ground. When a command is given, the owner can grab the line or step on it, saying “AAAT” all the way to the dog and reinforcing the command if need be by placing his shoulders at a slight angle and positioning his teeth over the dog's shoulder (FIG. 2). If the owner cannot watch and supervise the dog, then the dog needs to go in the second position, which is in the kennel or crate. The third position is outside, on the line and under the owner's supervision.

When the dog lags or doesn't want to follow, thus showing a passive way of resisting the authority that the trainer (owner) is trying to implement, some, three for example, quick pops are to be made on the line. At the same time, a command “COME ON” is pronounced once, twice or thrice with a barking intonation. Generally, commands are given in a barking tone of voice. They are very stern in sound, as there must be no mistake in the dogs mind that if they don't fulfill the command, the trainer will bite. If the dog still doesn't want to follow, the trainer is supposed to put the line to his waist and run several steps, then slow down and praise the dog in a high pitch howling voice saying “GOOD DOG” (or “GOOD BOY” or “GOOD GIRL”).

In the case the dog goes to the left whether it is sniffing or just avoiding, a quick pop has to be given with the left hand towards the right direction, in combination with saying very distinctly “NO SNIFF” if the dog is sniffing, or “AAGH” if the dog just goes to the side accompanied by a very brief moment of freezing and a stern (warning) facial expression when correction is given. This warns the dog not to do this again and is then instantly followed by praise informing the dog that it is now in the correct position. If the dog goes to the right, thus tying a person up from behind, quick pops have to be given with the left hand to the left to guide the dog back to the trainer's left side. In this case the command is preferably UUUGH, and it is pronounced once, twice or thrice, until the dog is back on the left side, after which a reward follows with a high-pitch praise saying “GOOD DOG.”

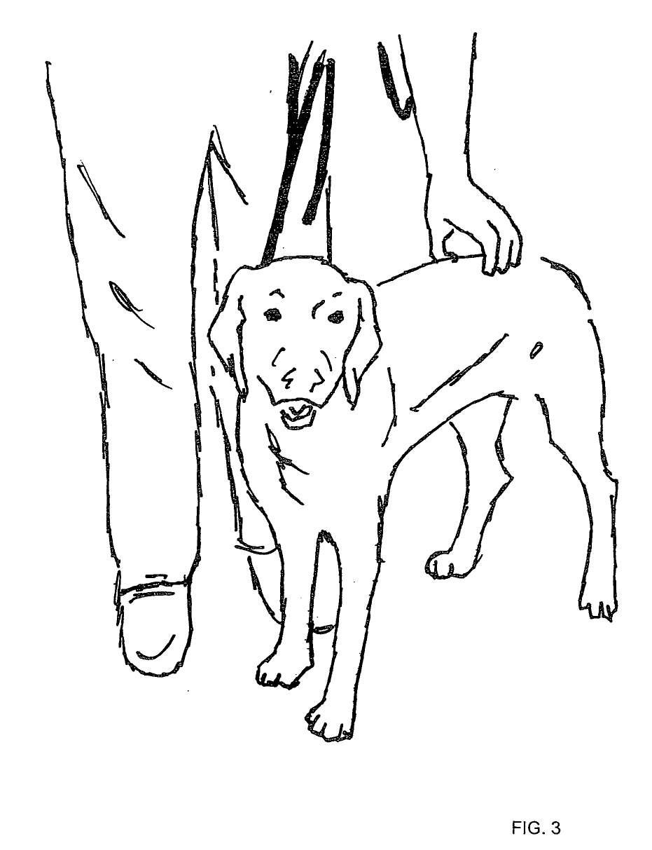

To train a SIT command, canine skills are utilized. The trainer can do this while walking or standing still. His right hand index finger and the thumb open up to grab the line below the left hand, which allows the trainer to be ready if the dog chooses otherwise. Simultaneously, he leans with his left shoulder over the dogs' shoulder at slight angle placing his teeth over dog's shoulder, thus conveying a message of dominance perceived by the dog in the way that if the trainer gets taller, the dog will get lower (FIG. 2), as he says “SSST”. The command is pronounced in a commanding tone of voice with a stern facial expression warning the dog that consequences will follow if it does not sit. Also, “SIT” is supposed to be enunciated as “SSST” as this is picked up by the dog's hearing more distinctly than just “SIT” with its much higher overtone. This sound does sound like a silent dog whistle, and the dog does hear this sound on a higher octave as compared with saying “SIT.” There is no correction being given at this time. However, the above “to be ready” implies that the trainer, with his left hand being under the right hand, actually freezes and is about to reinforce or correct if the dog does not sit. If the dog shows it thinks it has choices, the trainer can reinforce the command by using fingers (teeth) to imitate biting the rump (FIG. 3) and simultaneously give a quick pop up on the line simulating biting around the neck as dogs behave among themselves in a similar situation.

If the dog breaks the sit stay, the trainer steps forward, gives a quick upward pop and says “AAAT”. If the dog breaks and moves, the trainer first gives a pop marking the point of error and says “AAAT” once or, preferably, several times (as if he said WRONG to a human) as he takes the dog all the way back to the exact spot where it left. This command becomes more verbal than physical. When the dog is once again sitting and staying, the praise “GOOD DOG” in a high pitch canine language (as if saying RIGHT to a human) follows.

Utilizing the inflection of trainer's voice is conducive to the distinctness in pronouncing commands and conveying its meaning to the dog. For example, “STAAAY” is to be pronounced in a firm, determined and drawn out voice. This is understood by the dog as “GRRRR,” don't follow. The body posture, frozen momentarily (along with the stern warning facial expression), is tall and erect instilling calm confidence.

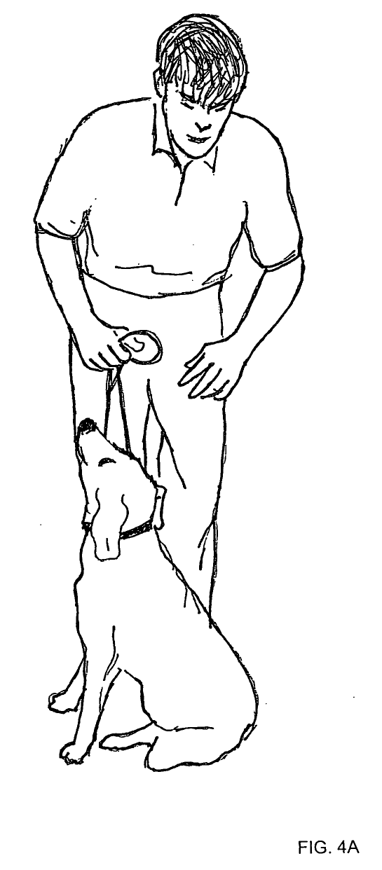

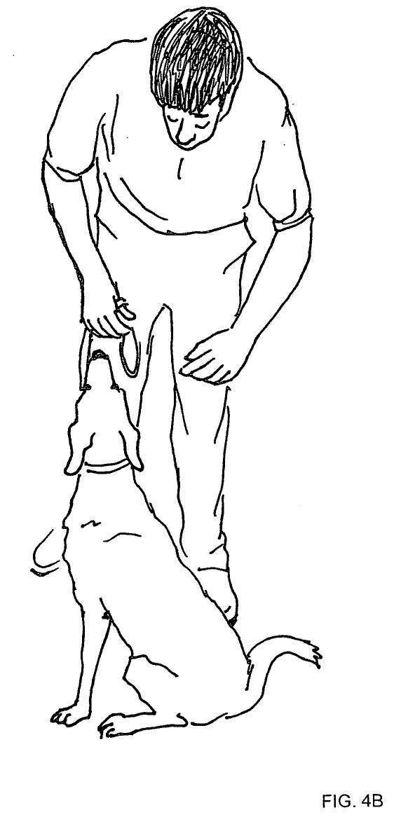

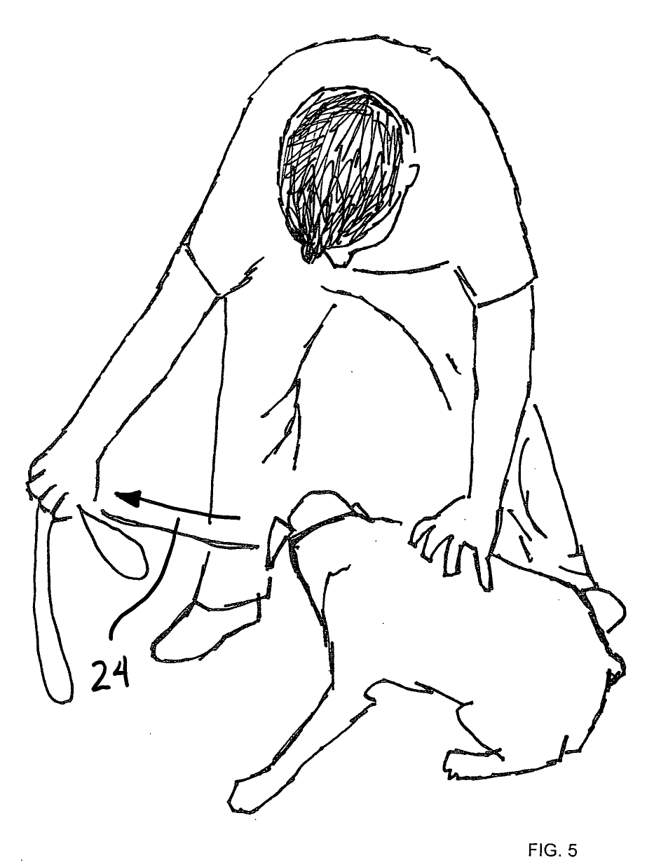

Training the DOWN starts with the dog sitting or standing. The trainer's left foot is placed close to the rear of the dog, the right foot being a shoulder width apart and both feet being perpendicular to the dog. The line is gathered up, and the trainer slightly bends over the dog (FIG. 4A). Then the dog's name is pronounced adding “DOWN” (or just “DOWN,” without the name) in a descending commanding (growling) intonation of voice producing sort of “OWN.” At the same time, the right foot suddenly moves out slightly to the right and the trainer's shoulders bend further forward and slightly down, which positions trainer's teeth over the dog's shoulder (FIG. 4b). If the dog doesn't go down, the trainer will need to reinforce the command given. The unique way of correcting again uses forming the fingers on the left hand like teeth (the “C”-shape). The left fingers then are pushed toward the dog's shoulder blades, whereas the right hand simultaneously administers a quick pop towards the front. (24 in FIG. 5).

Summarizing reinforcing commands using the line, it is to be understood that they are different depending on the situation and primary commands given. For example, when correcting stay, the handler's actions will be different when the dog breaks the sit stay compared with when it breaks the down stay, as described in the above paragraphs. The line would be used to correct the dog for jumping by sharply snapping or popping the dog back onto its four paws. This whole motion is a sequence of snapping the line, stepping forward in an threatening assertive manner, freezing, saying AAAT and having a very stern expression on the handler's face. The line would also be used to reinforce “COME”. If the dog doesn't come, the handler would grab the line, give a quick snap or pop on the line, and say “come” while stepping backwards. The moment that the line is snapped, the handler would momentarily freeze and have a very stern facial expression.

As the dog's needs are met, be it physical, mental or social, its behavior problems fade away fast. These needs can be met by daily exercising and doing aerobic-type exercises, running back and forth. Then mental by doing our special obedience training and social depending on the prior two. The owner is expected to have to help the dog meet these three major needs. The dog must be physically tired through exercise and mentally tired through obedience, and now the owner can let the dog be part of the human social pack, the result being having a dog that the owner can take anywhere and trust.

Also, the inventors came up with an exercise that can change the dog's perception of being touched, handled and accepting human authority, a technique that can be called a dominance/relaxation exercise and that actually precedes the steps of the method disclosed in the above. The exercise is different than what most trainers call an alpha roll in how they utilize their hands and body. It is also different to the dog in that they are held by humans not as a human would hold them down, but in how another dog or mother dog would dominate them. This dominance/relaxation exercise is included as a part of the current method, and it is routinely done several times a day. The benefits are surmountable at curing aggressiveness, hyper-activity, dog's feeling of vulnerability or insecurity and over-all general disobedience. It also has an indirect affect on curing behavior problems. It can be seen time and time again how dogs change as they learn to accept human authority. The reasons are clear, dogs naturally feel more secure, confident and submissive when they know that rules are established, reinforced, and a confident strong leader is present. In the case of puppies, it is so beneficial at preventing aggression and other dominance related behavioral problems, that a puppies' life can be changed forever just by implementing this procedure.

This unique dominance/relaxation exercise has a calming therapeutic affect on dogs. It was discovered that by implementing this exercise a dog will learn to accept and trust any type of human touch and authority. It entertains the notion that an owner or care giver can trim toe nails, groom, clean ears or any other activity that requires restraining, touching and handling of the dog. The dog learns to relax and become calm whenever someone is handling them, because the dog has learned to accept human authority.

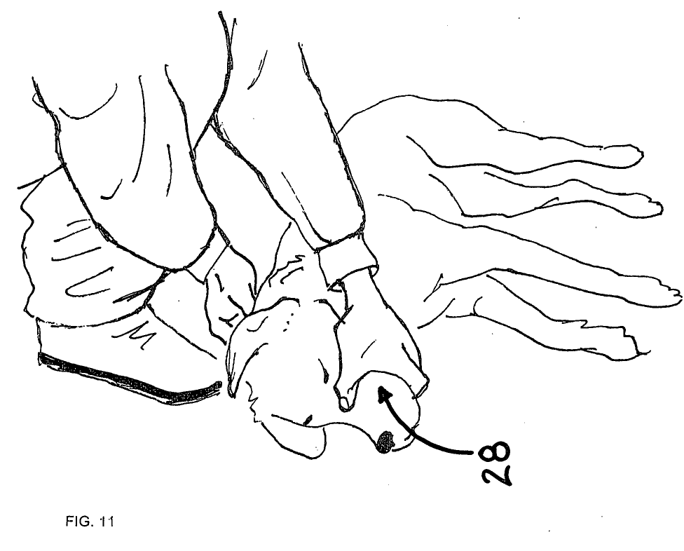

For larger dogs preferably, but not limited to them only, the dominance/relaxation exercise is implemented by having the dog either standing or sitting, preferably sitting, with the owner standing. Generally the dog's head is facing towards owner's right hand, the dog's rump area being braced against the left foot and the spine being perpendicular to the owner's feet. The following technique would be transposed or mirrored if the dog's head and body are facing the opposite direction. The owner will hold or grab the collar in the right hand and place the left hand on the side of the dog's body that is opposite to the side that is near the owner's leg. The left hand will grab or simulate biting in the area of the chest that is just above the front leg (26 in FIG. 9). From this position the owner will simultaneously twist the right hand towards himself in a counter clockwise motion, as if he were turning a wrench, this raising the dog up slightly and pushing the dog's head and shoulders onto the leg. Simultaneously the left hand pushes the dog into the owner's leg. This action places the dog's body onto the leg (FIG. 10).

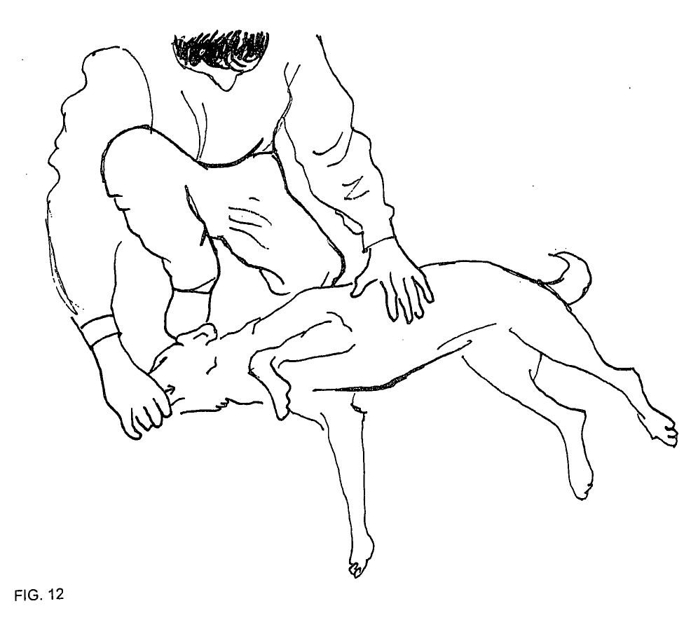

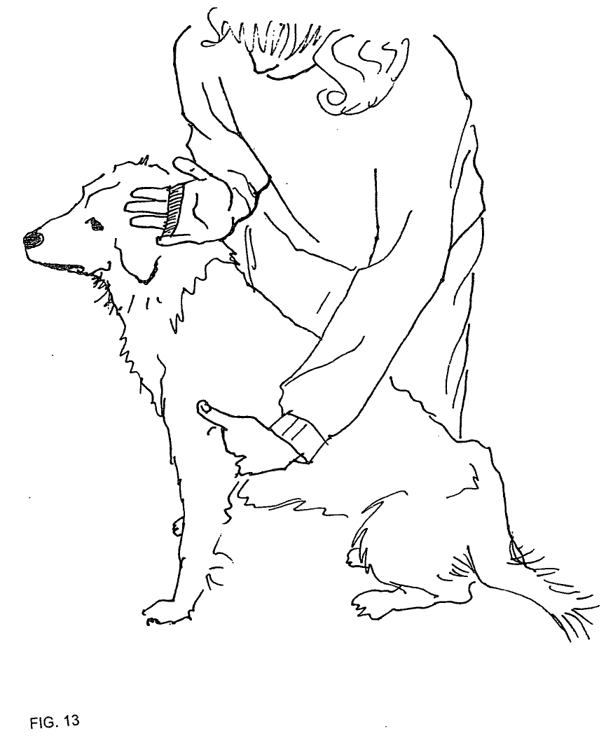

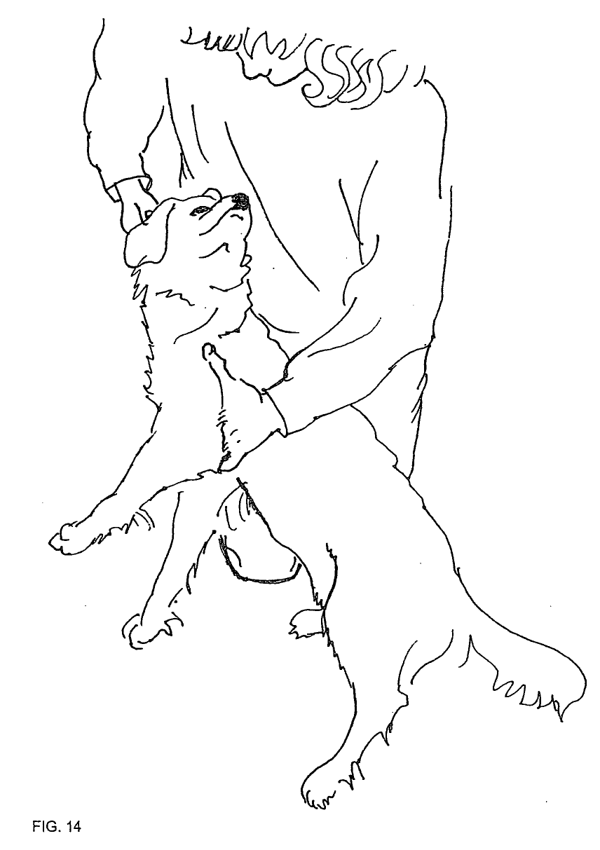

Then the owner will slightly move back and the dog's body will gently slide down the leg placing the dog sideways in the down position. Once the dog is down on its side, the owner will gently glide the left hand along the dog's head until the fingers enclose the muzzle (28 in FIG. 11). The right hand still holds the dog down by the collar. The left thumb will be placed on top of the jaw, the other fingers being planted under the jaw gently keeping the mouth closed (FIG. 11). Once again, the hands are being used as a jaw and the fingers as teeth, an exact simulation to what a mother dog would do. The dog will have to be held in this position until it accepts human authority. Thus the dog is going to loose its social status and accept the owner's higher social status. Once the dog relaxes as it would with its own mom, than the hands are switched. The right hand will go to the muzzle to continue holding it gently closed, whereas the left hand goes to the dog's chest (FIG. 12). Now the dog is completely relaxed, is accepting owner's authority, and can be touched and handled. This imitates how a mother dog would hold down their puppies. Enclosing the muzzle with the hand is also like a dog would grab another dog's muzzle to enforce its dominance.

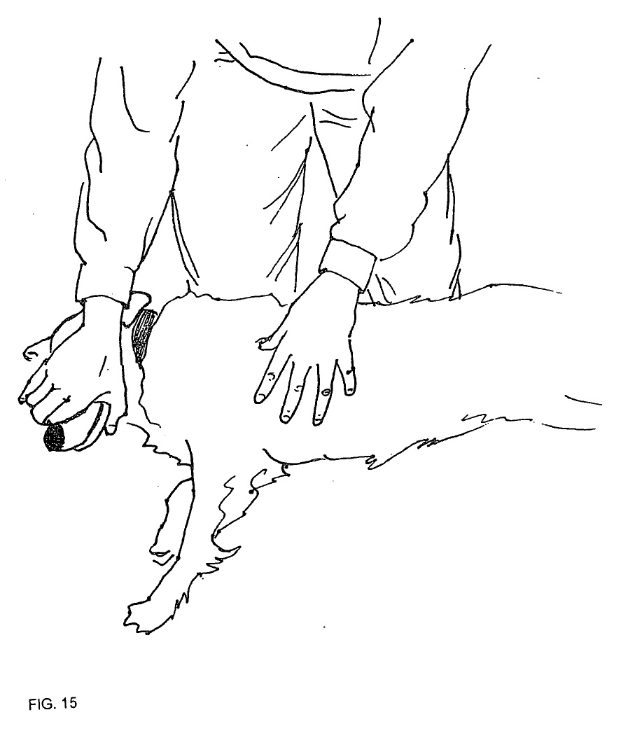

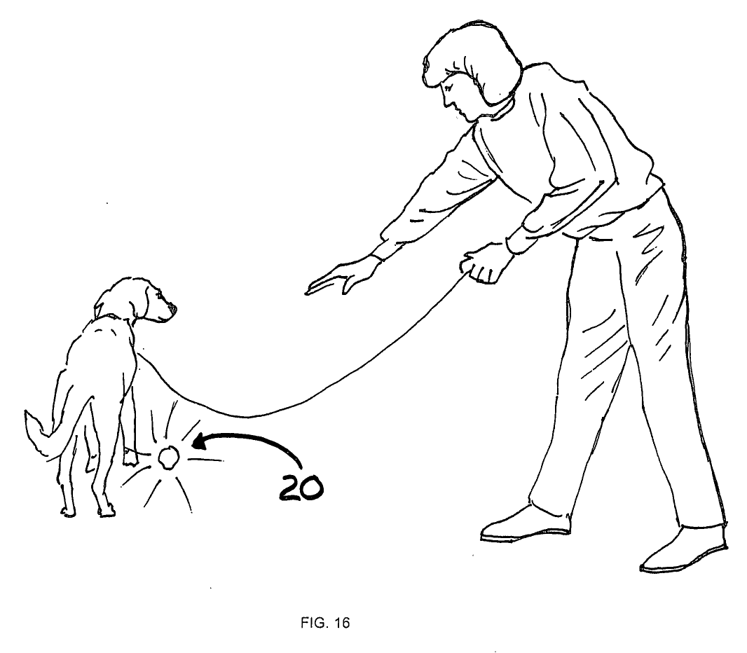

For non-aggressive small dogs or puppies, though not limited to them, the start is kneeling upright. It should be made sure that the dog's rump is resting up against the left knee. The right hand is placed under the collar palm up to point towards the dog's head, with the thumb facing the owner. The left hand is placed above the dog's elbow where the leg meets the chest (FIG. 13). Then, the right hand is twisted towards the owner's body in a counter clock-wise fashion. The left hand slightly lifts the body as the dog's body is being pulled onto the leg (FIG. 14). From here, the owner starts to sit back onto the heels of the feet as he slightly moves his legs backwards and simply lets the dog's body gently slide off the legs and onto the floor on its side. With the right hand still holding down the collar, the left hand is placed palm down onto the side of the dog's chest. The right hand will then gently glide along the dog's head until the fingers enclose the jaw. The right thumb plants itself under the jaw and the fingers gentle keep the mouth closed (FIG. 15). Often the jaw is held closed simply by the right thumb and index finger.

Once the dog has settled, the right hand around the muzzle is released, keeping the left hand still planted on the chest. Here, the dog can be very calmly praised, stroked, and all parts of the dog's body can be touched, especially the feet, ears and teeth. The dog is learning to accept owner's authority and loving touch. This is no different than a mother dog when she turns over her puppies to groom them or holds them down to discipline them.

In either case, be it large or small dogs, if the dog again starts to struggle or lifts up its head, owner's right hand slides again towards the dog's muzzle, closes the mouth, and a firm but slight shake is given accompanied by saying AAAHT, freezing and giving a stern look. When the dog relaxes, the right hand is again released from the muzzle and again calm praising, stroking and touching is given to the dog.

While the present invention is described hereinabove with regard to training a dog to follow several fundamental commands, it is understood that without departure from the spirit and scope of the invention as claimed in the below claims, its principles and steps are fully applicable to training other commands required in everyday relationship of the owner and his dog.

What is claimed is:

1. A method of training a dog comprising the steps of
providing a line connecting a trainer with the dog to ensure a leading position of the trainer,
generating a message of a command by the trainer, the command being pronounced in an assertive fashion and with a stern facial expression, and
creating a frozen posture by the trainer mimicking a threat in canine language,
to thereby produce in the dog an instinctive perception of the threat of an inevitable bite in case of disobedience.

2. The method according to claim 1, wherein the line is made thin enough to avoid creating a feeling in the dog of being tethered.

3. The method according to claim 1, wherein the message is generated with ascending intonation.

4. The method according to claim 1, wherein the message is generated with descending intonation.

5. The method according to claim 1, further providing an acoustic bag that emits a clearly distinguishable sound when having been thrown and thus surprises the dog and interrupts its unwanted behavior bringing it to a halt.

6. The method according to claim 1, wherein ensuring the leading position of the trainer is achieved by a swift trainer's body motion, said body motion being in a reverse direction with regard to a dog's forward motion, and by a scissor-like motion of trainer's hands, to thereby create a snap on the line, preferably prior to a dog's pulling action, and to take the dog aback, whereby dog's attention is intercepted, surprise is formed in it, and transformation of the dog from a leader to a follower is thus secured.

7. The method according to claim 1, wherein ensuring the leading position of the trainer, preferably when training small or sensitive dogs, is achieved by trainer's swift stepping back when the dog gets ahead, pivoting around in the opposite direction with regard to a dog's forward motion while keeping his left hand slightly behind him, and popping the line forth and back, to thereby take the dog aback, whereby dog's attention is intercepted, surprise is formed in it, and the transformation of the dog from a leader to a follower is thus secured.

8. The method according to claim 1, further comprising a step of trainer's leaning over the dog, to thereby create perception in the dog that the trainer is taller than the dog, whereby a message of dominance is conveyed to the dog to achieve a sit.

9. The method according to claim 8, further comprising reinforcing the command by using a hand and fingers as jaws and teeth and touching the dog's rump to imitate biting.

10. The method according to claim 8, further comprising reinforcing the command by giving a quick pop up on the line simulating biting around the neck.

11. The method according to claim 1, further providing a reward to consolidate progress in training and make it habitual, the reward being provided by generating a high-pitch intonation message of gratitude.

12. The method according to claim 11, further providing a treat to the dog.

13. A method of training a dog comprising the steps of
providing a line connecting a trainer with the dog to ensure a leading position of the trainer,
pronouncing a command by the trainer, the command being pronounced with descending intonation, and
creating a frozen body posture with a stern eye contact by the trainer,
to thereby produce in the dog an instinctive perception of a threat of an inevitable bite in case of disobedience.

14. The method according to claim 13, wherein the message is generated in an assertive growling fashion.

15. The method according to claim 13, further providing an acoustic bag that emits a clearly distinguishable sound when flying in the air and thus surprises the dog and interrupts its unwanted behavior bringing it to a halt.

16. The method according to claim 13, wherein ensuring the leading position of the trainer is achieved by a swift trainer's body motion, said body motion being in a reverse direction with regard to a dog's forward motion, and by a scissor-like motion of trainer's hands, to thereby create a snap on the line, preferably prior to a dog's pulling action, and to take the dog aback, whereby dog's attention is intercepted, surprise is formed in it, and transformation of the dog from a leader to a follower is thus secured.

17. The method according to claim 13, wherein ensuring the leading position of the trainer, preferably when training small or sensitive dogs, is achieved by trainer's swift stepping back when the dog gets ahead, pivoting around in the opposite direction with regard to a dog's forward motion while keeping his left hand slightly behind him, and popping the line forth and back, to thereby take the dog aback, whereby dog's attention is intercepted, surprise is formed in it, and the transformation of the dog from a leader to a follower is thus secured.

18. The method according to claim 13, further comprising a step of reinforcing the command by trainer's leaning over the dog, to thereby create perception in the dog that the trainer is taller than the dog, whereby a message of dominance is conveyed to the dog.

19. The method according to claim 18, further comprising reinforcing the command by using a hand and fingers as jaws and teeth and touching the dog's rump to imitate biting and giving a quick pop up on the line simulating biting around the neck of the dog.

20. The method according to claim 13, further providing a reward to consolidate progress in training and make it habitual, the reward being a high-pitch intonation message of gratitude and a treat to the dog.
